(19) United States
(12) Patent Application Publication
(10) Pub. No.: US 2012/0174527 A1
(43) Pub. Date: Jul. 12, 2012

(54) FRAME CONSTRUCTION METHOD AND APPARATUS

(75) Inventors: Foster D. Hinshaw, Cambridge, MA (US); William J. Fosnight, Saratoga Springs, NY (US)

(73) Assignee: Dunmow Systems Corporation, Cambridge, MA (US)

(21) Appl. No.: 13/324,700

(22) Filed: Dec. 13, 2011

Related U.S. Application Data
(60) Provisional application No. 61/422,476, filed on Dec. 13, 2010.

(51) Int. Cl. E04B 1/19; B23P 19/04; B27F 7/09; E04F 21/00

(52) U.S. Cl. 52/745.13; 52/749.1; 29/798; 227/19

(57) ABSTRACT

A method of framing a structure at a job site. The method of framing has a step of providing a framing material kit having framing components, the framing components being pre cut to length and size to form at least a portion of the structure, the framing components having mating pins and mating sockets that mate during assembly of the structure. A step of assembling mating framing components from the framing components to form the portion of the structure by mating the mating pins and the mating sockets and fastening the mating framing components together is provided.

### RELATED APPLICATIONS

This application claims the benefit of and priority from U.S. Provisional Patent Application Ser. No. 61/422,476 Entitled “FRAME CONSTRUCTION METHOD AND APPARATUS” and filed on Dec. 13, 2010 which is hereby incorporated by reference herein in its entirety.

### BACKGROUND

1. Field

The disclosed embodiments relate to a frame construction method and apparatus and, more particularly, to a frame construction method and apparatus adapted to produce framed structures.

2. Brief Description of Earlier Developments

Home or commercial construction projects often involve framing carpentry. Typical construction involves a dimensioned plan and a specification reflecting the desired construction provided to carpenters or a framing crew. The amount of dimensioned lumber is determined, ordered and delivered to the construction site. Although some of the lumber may be provided cut to length, for example, wall studs, much of the lumber needs to be cut to length from larger pieces of the dimensioned lumber. Cutting the lumber to the desired size may be performed using tape measures, squares, or otherwise used in combination with chop saws or circular saws. Alternately, templates are made to facilitate quick marking and cutting. In parallel or after the lumber has been cut to size, framers manually mark the location of the framed construction and manually assemble the structure, typically starting with the sills, floor joists and floor, walls, ceiling and roof in the case of a simple one story home. The process tends to be time consuming and costly as much of the cutting, measurement, marking, locating and fastening is manual, time consuming and labor intensive and is subject to inaccuracies due to communication errors and the quality of the carpenters and framing crew. Accordingly, there is a desire to reduce the time, cost and inaccuracies associated with manual home structure framing and sheathing.

### BRIEF DESCRIPTION OF THE DRAWINGS

The foregoing aspects and other features of the exemplary embodiments are explained in the following description, taken in connection with the accompanying drawings, wherein:

FIG. 1 is an isometric view of a job site;

FIG. 2 is a top view of a floor section;

FIG. 3 is a section view of a floor section;

FIG. 4 is a section view of a pin and socket;

FIG. 5 is a section view of a pin and socket;

FIG. 6 is a section view of a wall;

FIG. 7 is a section view of a rafter and tie beam;

FIG. 8 is a double plate and rafter;

FIG. 9 is a top view of an alignment fixture;

FIG. 10 is a side view of an alignment fixture;

FIG. 11 is an isometric view of an alignment fixture;

FIG. 12 is an isometric view of an alignment fixture;

FIG. 13 is an exploded isometric view of an alignment fixture;

FIG. 14A is a side view of an alignment fixture;

FIG. 14B is a side view of an alignment fixture;

FIG. 15 is a isometric view of a pin setter;

FIG. 16 is a top view of a pin setter;

FIG. 17 is a end view of a pin setter;

FIG. 18 is a side view of a pin setter;

FIG. 19 is an exploded isometric view of a pin setter; and

FIG. 20 is a process flow diagram.

### DETAILED DESCRIPTION OF THE EXEMPLARY EMBODIMENT(S)

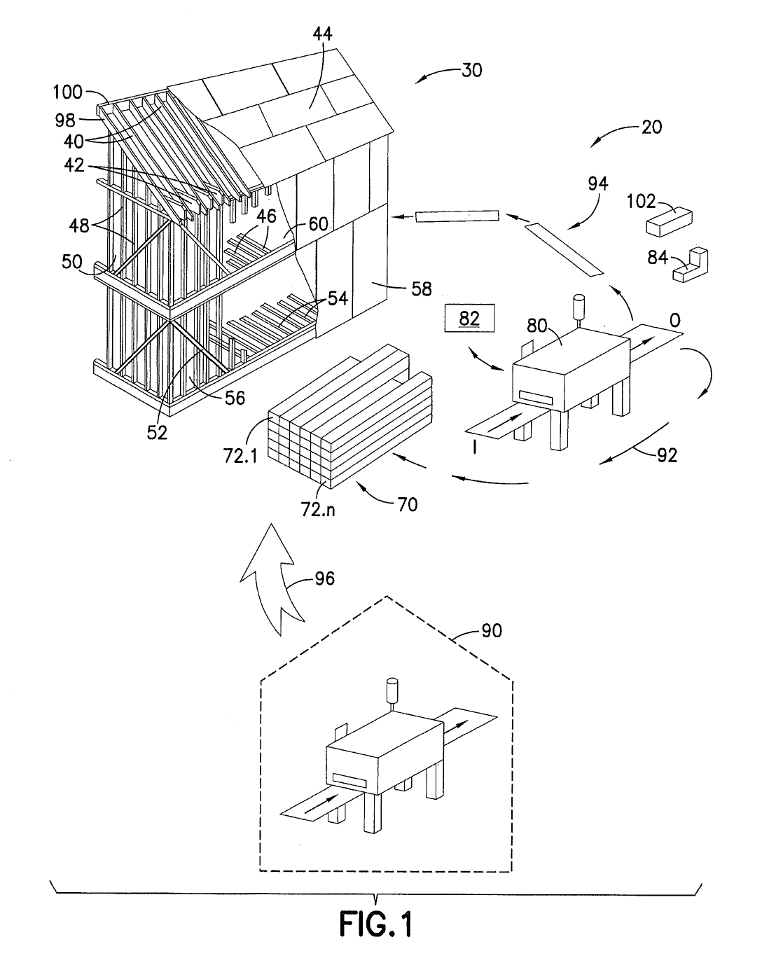

Referring to FIG. 1, there is shown, an isometric view of a job site having framed structure thereon in residential or commercial construction or otherwise incorporating features in accordance with an exemplary method and embodiment. Although the present invention will be described with reference to the embodiments shown in the drawings, it should be understood that the present invention can be embodied in many alternate forms of embodiments. In addition, any suitable size, shape or type of elements or materials could be used.

Job site 20 has structure 30 made of framed and sheathed components. Although the structure 30 will be described with respect to framed and sheathed components of lumber, any suitable components, for example, metal, polymer, composite, masonry or otherwise may be used. Further, although structure 30 will be described with respect to framed and sheathed components, other components prior or subsequent to framing of structure 30 may be applied to the present embodiments. By way of example, interior or exterior trim components, siding or roofing components, hybrid sheathing and siding components, kitchen and bath components, wall finishing components such as sheetrock or otherwise, interior or exterior masonry and supporting structures or other suitable component part or subassembly. Structure 30 may be made of roof rafters 40, ceiling joists 42, roof sheathing 44, floor joists 46, second floor wall studs 48, sub floor 50, 60, corner bracing 52, floor joists 54, sub floor 56 and sheathing 58. In alternate embodiments, more or less components may be provided. In the exemplary shown, framing material kit is provided having framing components 72.1 . . . 72.n where n may be any number corresponding to the number of components required to make up a desired structure or portion of a structure and may include components, for example, cross bracing or otherwise required to assemble the structure but not part of the completed structure. Components 72.1 . . . 72.n may be placed in a logical order such that as components are removed, they logically are in the order of assembly. As previously described, the components may comprise any desired components that make up the completed structure in addition to supporting components if needed. Examples of supporting components may include fasteners, ancillary building supplies, construction tools or components as identified in U.S. Provisional Patent Application Ser. No. 61/422,501 filed on Dec. 13, 2010 and entitled “Construction Material Handling Method and Apparatus” and U.S. Provisional Patent Application Ser. No. 61/422,508 filed on Dec. 13, 2010 and entitled “Construction Fastening and Locating System and Method”, both hereby incorporated by reference herein in their entirety. Although shown made up of stick lumber, kit 70 may contain combinations of materials, for example, stick lumber and sheathing and/or flooring. Alternately, kit 70 may include prefabricated sub assemblies, for example, wall or floor or other suitable sections or portions which may include components. In the embodiment shown, the framing components 70 are pre cut to length and size to form at least a portion of the structure 30. By way of example, kit 70 may comprise the framing and sheathing required to assemble the roof structure of structure 30 or alternately, one or more walls having a kit with mating components or floors or otherwise. As will be shown and described in greater detail below by way of example, the framing components may have mating features, for example, pins and mating sockets that mate during assembly of the structure. The mating features may be applied to any suitable mating portion of structure 30. For example, there may be one, two or otherwise more or less mating features per joint as desired based on the joint application where the mating features may locate and align. The mating features may be such that incorrect assembly is indicated, for example, where mating features are offset where components are mis-aligned if not in the correct orientation. The mating structures may include rafters, floor joists, prefabricated sills and having mating features, such as pins and sockets in any suitable mating surface(s) or otherwise and may be any suitable joint as needed. The lumber may be cut to size manually, semi automatically or automatically on at any suitable platform. A suitable example is stick machine 80 disclosed in U.S. patent application Ser. No. 13/178,138 filed Jul. 7, 2011 entitled “Automated Stick-Frame System” which is hereby incorporated by reference in its entirety. Stick machine 80 may be provided to manufacture lots of lumber, for example CNC cutting, identification, drilling for electrical or plumbing, marking circuits, electrical boxes etc. . . . In alternate embodiments, more or less functions may be provided. Exemplary stick machine 80 may be an automated system that produces stick-frame construction components, for example, studs, top plates, bottom plates, joists, rafters, blocking or otherwise from standard dimensional lumber. Machine 80 may receive CAD data translated from a framing model in server 82. A suitable example of server is disclosed in U.S. patent application Ser. No. 13/178,344 filed Jul. 7, 2011 entitled “Construction Control System” which is hereby incorporated by reference in its entirety. Stick machine cuts boards to length and may be provided with adjustable miter and bevel, drills holes for electrical and plumbing, marks, for example, board ID, stud locations, hole ID—electrical circuit or plumbing ID, electrical outlet locations, switch locations, data cables or otherwise. Machine 80 may also drill mating features, such as holes or slots for pinned connections to bottom of panels, top of panels, at stud locations or otherwise to permit alignment or otherwise and may install mating pins or features. Stick machine 80 may be fed 2″×3″ through 2″×12″ lumber and may prompt a user to load appropriate board length that minimizes waste of parts to be produced. Machine 80 may be portable to job site or location proximate home construction or located remote such as at site 90. As will be described below, and in alternate embodiments, pin setter 84 may be used to install mating pins or features. In alternate embodiments, pin setter 84 may be incorporated in stick machine 80. Kit 70 may be assembled at job site 20 as material is fed 92 from machine 80. Alternately, Kit 70 may be delivered 94 and assembled in real time on site 20. Alternately, Kit 70 may be assembled at a site 90 different than job site 20 and transported or shipped to job site 20. Mating framing components, for example, components 98, 100 from framing components in kit 70 may form a portion of structure 30 where components 98, 100 may mate mating features, for example, mating pins and mating sockets where components may be fastened together after mating. As will be described below, tools, such as T-nailer 102 may be provided to facilitate assembly. In alternate embodiments, any suitable tools may be provided to facilitate assembly. As will be shown below, one or more fastener(s) may be provided embedded or partially embedded in the component to facilitate quick assembly. Here, a portion of framing components 70.1 . . . 70.n in kit 70 may have at least one fastener pre set in the framing component, the fastener provided to fasten at least a portion of the mating framing components together. Additionally, a portion or all of the framing components may have identification indicia, with the identification indicia indicating where the mating framing components are to mate and/or indicating which of the mating framing components mate and/or an order that the framing components are to be assembled, a component identification, unique or by group or otherwise and/or any suitable identification indicia. In alternate embodiments, any suitable mating feature, fastener or identification indicia or otherwise may be provided on the components of kit 70 to facilitate ease of assembly, fool proof assembly or ease of alignment.

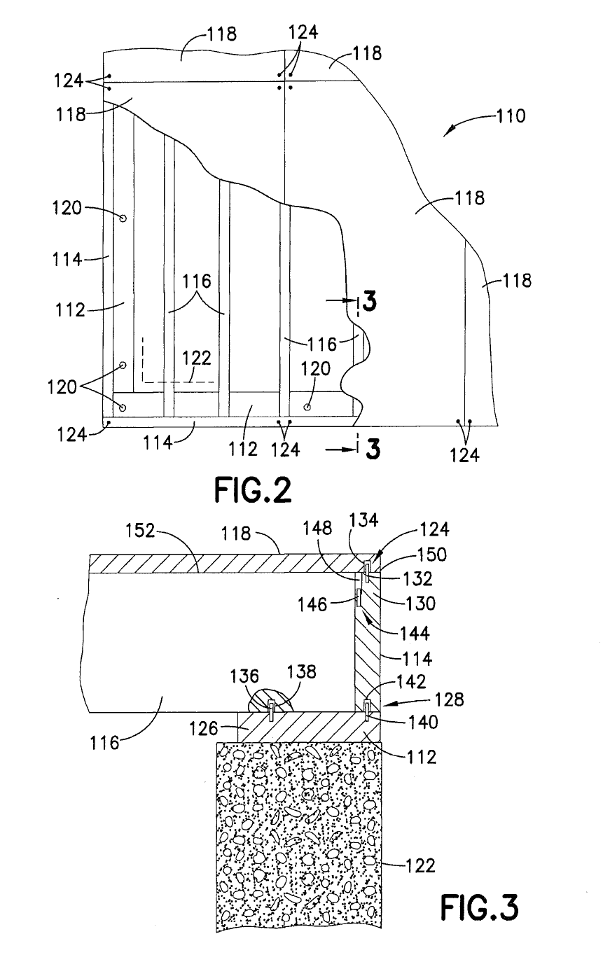

Referring now to FIG. 2 there is shown a top view of a floor section 110. Floor section 110 has sills 112, sill plates 114, floor joists 116 and sub flooring 118 where anchor bolts 120 tie sills 112 to foundation 122. Referring also to FIG. 3 there is shown a section view 3-3 of floor section 110. In the embodiments shown, mating features may be provided to align from sill plates through wall structures from floor to floor providing continuous alignment from floor to floor to completion of any given structure as required. Mating features 124 may be provided to mate, for example, sub flooring 118 to floor joists 116 and sill plates 114. As previously described, the mating features may be pre installed on each component at each joint such that assembly may be done efficiently and accurately. An exemplary configuration is shown in section 3-3 where mating features 124, 126, 128 and 130 are shown. In alternate embodiments, more or less mating features may be provided in more or less locations and having any suitable geometry to facilitate ease of assembly. Mating feature 124 is shown having pin 132 in sill plate 114 located in mating hole, bore or slot 134 of sub flooring 118. Mating feature 126 is shown having pin 136 in sill 112 located in mating hole, bore or slot 138 of floor joist 116. Mating feature 128 is shown having pin 140 in sill 112 located in mating hole, bore or slot 142 of sill plate 114. Mating feature 144 is shown having pin 146 in floor joist 116 located in mating slot 148 of sill plate 114 where pin 146 drops into slot 148 and set such that upper surfaces 150, 152 of sill plate 114 and floor joist 116 are coincident such that sub flooring 118 remains level and flat. In many cases, the pin and mating feature may be interchanged as alternate embodiments. In alternate embodiments, more or less mating features of varying geometry's may be provided.

The embodiments of mating features shown in the following figures are meant to be exemplary where the mating features may be applied across a variety of construction joints and assemblies that are not depicted but intended to be covered. By way of example, mating alignment features may be provided to align construction portions, such as wall, floor or other suitable portions throughout the construction and framing process, for example, from floor to ceiling or from sill, through framed and built floors to the roof portion in continuous alignment in the construction process.

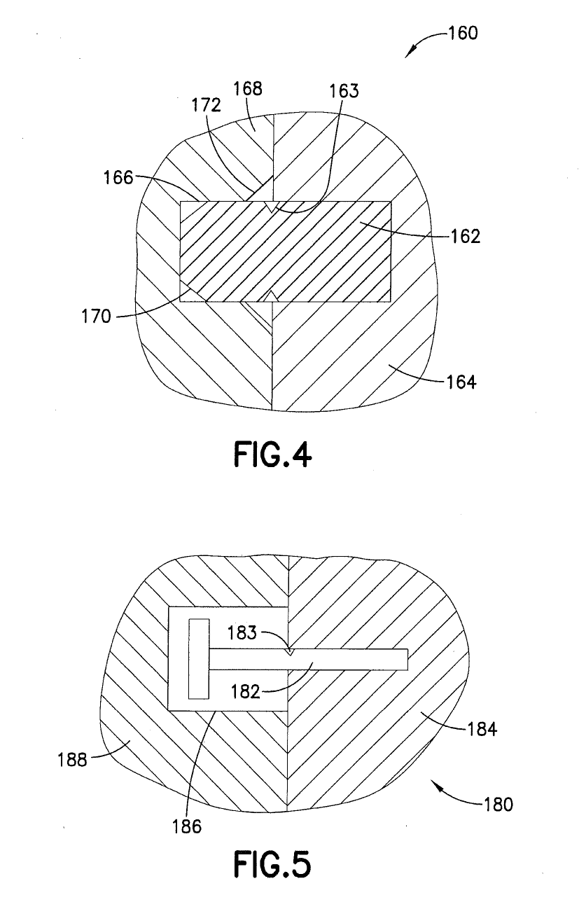

Referring now to FIG. 4, there is shown a section view of an exemplary pin and socket 160 alignment feature. Pin and socket 160 has chamfered pin 162 fixed in material 164 and lead in socket 166 in material 168. Chamfer 170 cooperates with counter sink 172 to facilitate aligned construction without having to hunt for the location. A tight fit may be provided between the pin and bore or a looser fit may be provided where clearance is acceptable. In alternate embodiments, socket 160 may comprise a slot where only a single direction of alignment is required. In alternate embodiments, any suitable shape may be provided to accomplish the desired alignment. Pin 162 may be a wooden dowel, a steel pin, a plastic pin or dowel or any suitable pin, dowel or locating device. Pin 162 may be easily removed, for example, by knocking off and/or breaking off, hitting with a hammer into the wood or by any suitable method. Removal may be required, for example, when boards are warped or otherwise mismatched. Pin 162 may have notch 163 facilitating easy knock off. Pin 162 may be sized suitably to provide sufficient strength for the application, for example, where a board is applying a load on pin 162 due to the application. Further, pin 162 and mating feature 166 may be sized so as not to compromise the structural integrity of the structural component

Referring now to FIG. 5, there is shown a section view of an exemplary pin and socket 180 alignment feature. Pin and socket 180 has T-pin 182 fixed in material 184 and socket 186 in material 188. In the embodiment shown, pin 182 may be a nail with a fixed depth. Although not shown, a counter sink may be provided to facilitate aligned construction without having to hunt for the location. A clearance fit is shown provided between the pin and bore where clearance is acceptable. In alternate embodiments, socket 180 may comprise a slot where only a single direction of alignment is required. In alternate embodiments, any suitable shape may be provided to accomplish the desired alignment. Pin 182 may be a wooden dowel, a steel pin, a plastic pin or dowel or any suitable pin, dowel or locating device. Pin 182 may be easily removed, for example, by knocking off and/or breaking off, hitting with a hammer into the wood or by any suitable method. Removal may be required, for example, when boards are warped or otherwise mismatched. Pin 182 may have notch 183 facilitating easy knock off. Pin 182 may be sized suitably to provide sufficient strength for the application, for example, where a board is applying a load on pin 182 due to the application. Further, pin 182 and mating feature 186 may be sized so as not to compromise the structural integrity of the structural component.

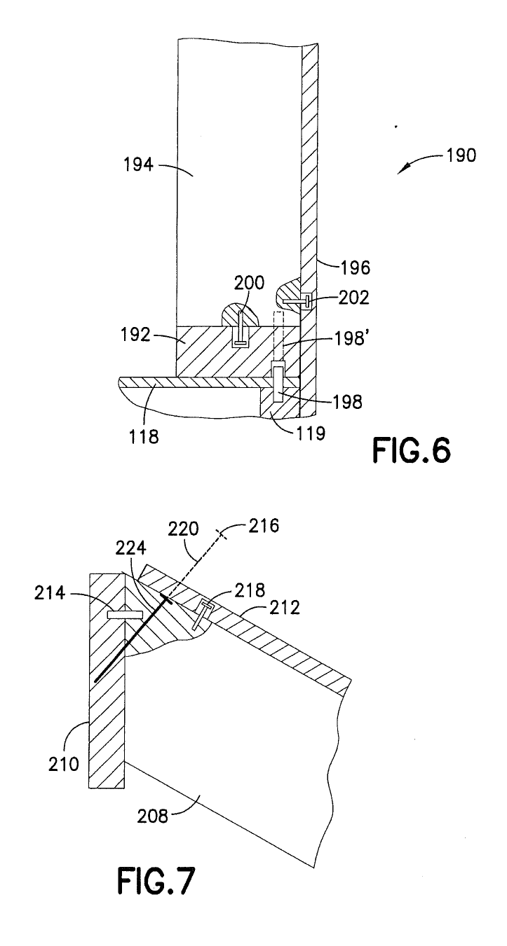

Referring now to FIG. 6 there is shown a section view of a wall 190 on sub floor 118. Wall 190 has sole plate 192, stud 194 and sheathing 196. In the embodiment shown, mating feature 198 has a pin provided in sill plate 114 that mates both sub floor 118 and sole plate 192. Further, mating features 200, 202 are provided to align stud 194 with sole plate 192 and sheathing 196 respectively. In alternate embodiments, more or less mating features of varying geometry's may be provided. For example, pin 198 may extend through sole plate 192 and into stud 194 as pin 198′. In alternate embodiments, pin 198′ may have originated as being embedded in stud 194 and used to locate sole plate 192 during assembly of sole plate 192, stud 194 and sheathing 196 where the same pin 198′ mates with a mating feature such as a hole or slot in sub floor 118 and/or sill plate 114.

Referring now to FIG. 7 there is shown a section view of rafter 210, tie beam 208 and roof sheathing 212. Mating feature 214 has a pin on rafter 208 and a mating socket in tie beam 210. A nail 216 is provided pre set in position 200 such that at assembly, nail 216 may be hit to position 224 allowing quick tacking of rafter 208 in position. Mating or alignment feature 218 is provided with a pin in rafter 208 and mating socket in roof sheathing 212. In alternate embodiments, more or less mating features of varying geometry's may be provided.

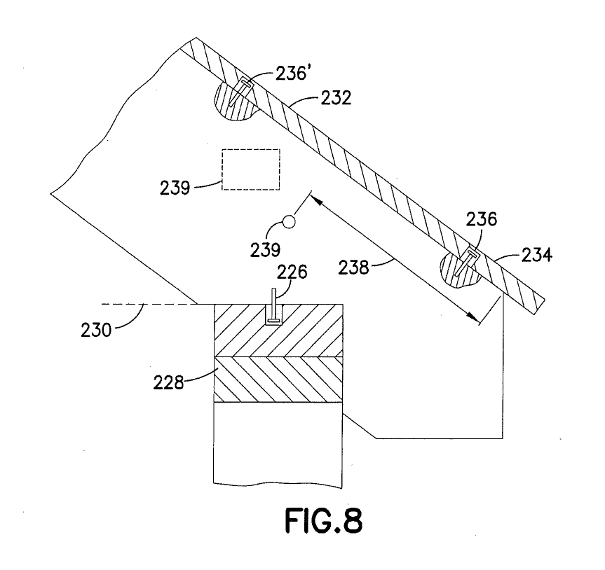

Referring now to FIG. 8 there is shown a double plate 228, rafter 232 and roof sheathing 234 with ceiling joist 230 not shown. Mating feature 226 has a pin in rafter 232 and mating socket in double plate 228. Mating feature 236 has a pin in rafter 232 and a mating hole or socket in roof sheathing 234. As sheathing is typically installed from the bottom working up, mating feature 236 on spaced rafters ensures sheathing is square and set up properly with respect to the rafters. Alternately, mating feature 236′ may be provided on the same rafter either alone to locate the piece of sheathing 234 or in combination with mating features on other rafters. In alternate embodiments, more or less mating features may be provided. The hole or socket in roof sheathing 234 may be sufficient for the first row of sheathing regardless of whether plywood, CDX, having tongue and groove features or otherwise. In second and subsequent rows a slot may be provided in the event of interference in assembly. Alternately, a hole or socket may be provided where installation allows, for example where the tongue and groove is engaged before or during engagement of the mating feature or otherwise. Hole 238 may be provided as a fiducial or reference point or location where a finishing step, such as a finish cut may be required. Here, prefabricated hole 238 may be provided, for example, by stick machine 80 or otherwise, ahead of time as a reference to indicate where the finish cut, for example a miter cut, is to be done, for example, as a fixed distance 238′ from the hole. Here, a user may manually make the mark and cut or a mating jig pin, stop or otherwise may be provided on the chop saw to ensure consistent cuts. Stick machine or other suitable apparatus or method may have marking or drilling capabilities, for example, to put fiducials on pieces for further processing. By way of further example, a roof rafter or other board with a series of complex cuts to be done on site may be needed. An exemplary complex cut may include a miter cut at 30 degrees and a bevel cut at 45 degrees where the board requires a straight cut on the opposing end and where the cut is to be done on a table saw outside of machine 80 without additional measuring and using a reference hole 238 as a fiducial. Here, a vertical pin may be placed on the feed table of a table saw, for example, six inches or otherwise from the centerline of the saw. Assuming that with this particular 30 degree miter and 45 degree bevel and the model table saw, the board must be placed, for example, 0.342 inches or otherwise from the board centerline to get the desired edge of the cut on line with the centerline. As part of the initial fabrication of the board with stick machine 80 or otherwise, a hole 238 may be drilled 6.342 inches from the end and the board may be pre marked with the desired miter and bevel. When the board is delivered to the table saw, the operator places the board on the feed table such that the alignment pin fits into the hole, sets the saw to the desired miter and bevel and makes the cut where a reliable and precise cut may be made without measuring on site. In alternate embodiments, any suitable combination of locating feature(s) may be provided on any suitable cut type or operation and with any suitable tool(s). Mark or instruction 239 may be pre printed on the rafter, for example, to indicate the location and type of cut to be performed with respect to the hole 238. Pin or Hole 238 may be offset from the center of the rafter such that an operator knows which side of the rafter to cut. In alternate embodiments, any suitable feature may be provided. In alternate embodiments, more or less mating features of varying geometry's may be provided.

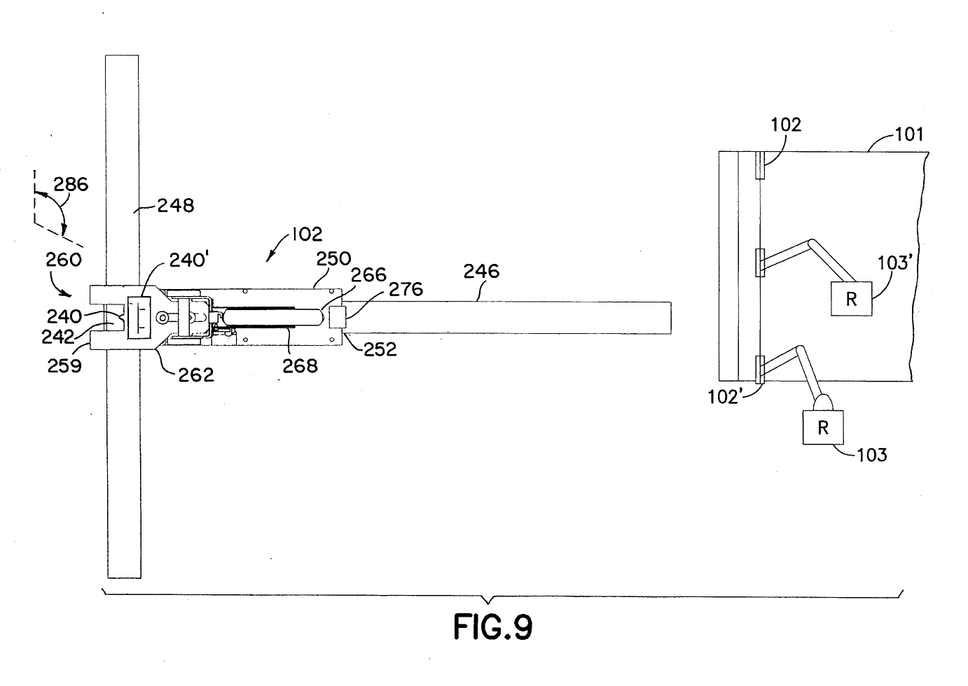

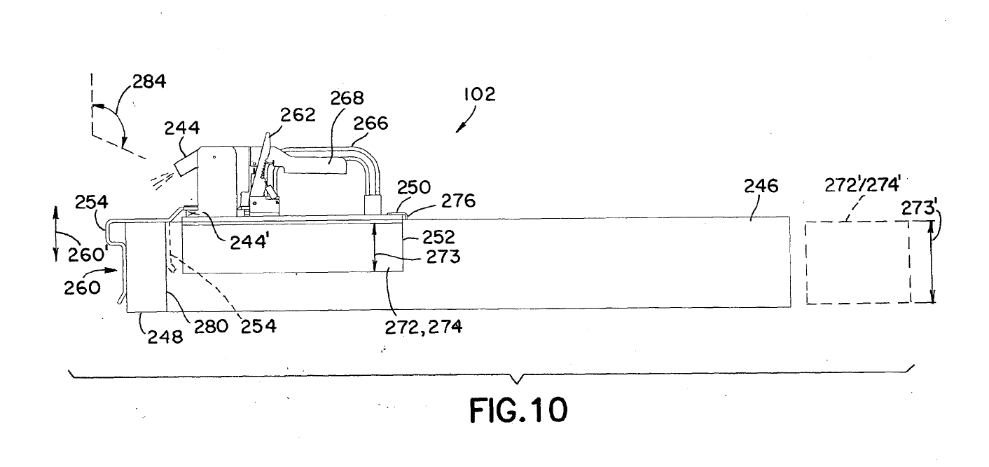

Referring now to FIG. 9 there is shown a top view of alignment fixture 102. Referring also to FIG. 10, there is shown a side view of alignment fixture 102. In the embodiment shown, alignment fixture 102 may also be referred to as a T-Nailer 102 where T-Nailer 102 aligns and holds studs or rafters to plate or beam respectively. T-Nailer 102 ensures accurate alignment and a tight, square joint. T-Nailer 102 also has a safety feature in that T-Nailer 102 removes an operators hand from the joint or work piece that has been known to be subjected to misfired or redirected nails, for example, when a nail hits a knot in the wood. T-Nailer 102 can use either visual fiducial 240 for alignment, for example, on indicia 242. In alternate embodiments, automatic detection means 244, for example, CCD or CCD array with image processor and visual or audible location indication to ensure alignment before tightening. View port 240′ may be provided to allow a user to see and identify that the joint is both engaged and that the surface of the lumber to be joined is flush or as desired. View port 240′ allows a user to see the joint to both make sure the height of the adjoining lumber is correct and to make sure the mating lumber properly abuts. As will be described below, tightening may be by manual grip with ratcheting capability. In alternate embodiments, T-Nailer 102 may be actuated by a motor or pneumatic cylinder. In the embodiment shown, T-Nailer 102 or alignment fixture 102 is shown adapted to align a first lumber component 246 with a second lumber component 248. Alignment fixture 102 has frame 250 and grip portion 252 coupled to frame 250. Grip portion 252 is adapted to grip first lumber component 246. Draw portion 254 is coupled to frame 250 with draw portion 254 adapted to draw second lumber component 248 in direction 260 toward first lumber component 246 in a fastening position as shown in FIGS.'s 9 and 10. Latch 262 is coupled to frame 250 with latch 262 adapted to hold the first lumber component 246 and the second lumber component 248 in the fastening position. Alignment fixture 102 is shown having handle 266 and grip lever 268. Grip portion 252 is shown having side plates 272, 274 and claw portion 276. In alternate embodiments, side plates 272, 274 may be flipped up or configured to enable nailing of double studs, triple studs, headers or otherwise. Side plates 272, 274 are shown having height 273. In alternate embodiments, height 273 may be closer to or as high as lumber portion 246 is wide or deep. In alternate embodiments interchangeable side plates 272′, 274′ may be provided having height 273′ different than height 273. Side plates 272′, 274′, may be interchanged with side plates 272, 274, for example, where different sizes of lumber are used, for example, 2×4, 2×8, 4×4 or otherwise. Joint 280 between first and second lumber component 246, 248 is shown as a perpendicular joint. In alternate embodiments, other angles may be provided, for example where a roof rafter is to be coupled to a tie beam where the perpendicular angle of FIG. 10 would be another angle 284. As a further example, where angled floor joists are provided where the perpendicular angle of FIG. 9 would be another angle 286. By way of further example, where a valley rafter couples to another rafter, a compound angle. Accordingly, an alternative embodiment involves where one or more angles between grip portion 252 and draw portion 254 are adjustable and settable and/or lockable between one or more axis forming a single or compound angle allowing fixture 102 to position a variety of framing configurations. In alternate embodiments, more or less alignment features may be provided. By way of example, a second draw portion 254′ may be provided to grip lumber 248 where cam 244′ is actuated, for example, by rotation of handle 266 to raise or lower lumber portion 248 with respect to lumber portion 246 prior to clamping in order to achieve proper alignment. Alternately, any suitable clamping and actuation portion may be provided to allow adjustment of the relative height of the lumber to be joined. In the embodiment shown, fixture 102 is shown as a manually used fixture in the assembly of structure 101. In alternate embodiments, fixture 102′ may be provided coupled to the wrist of robot 103 and working in conjunction with robot 103 to perform similar functions as fixture 102 working with a user. Here, fixture 102 would have the actuated functions automated where robot 103 may work with placement robot 103′ in the automation of assembly of structure 101. In alternate embodiments, more or less functions may be automated in the assembly of structure 101.

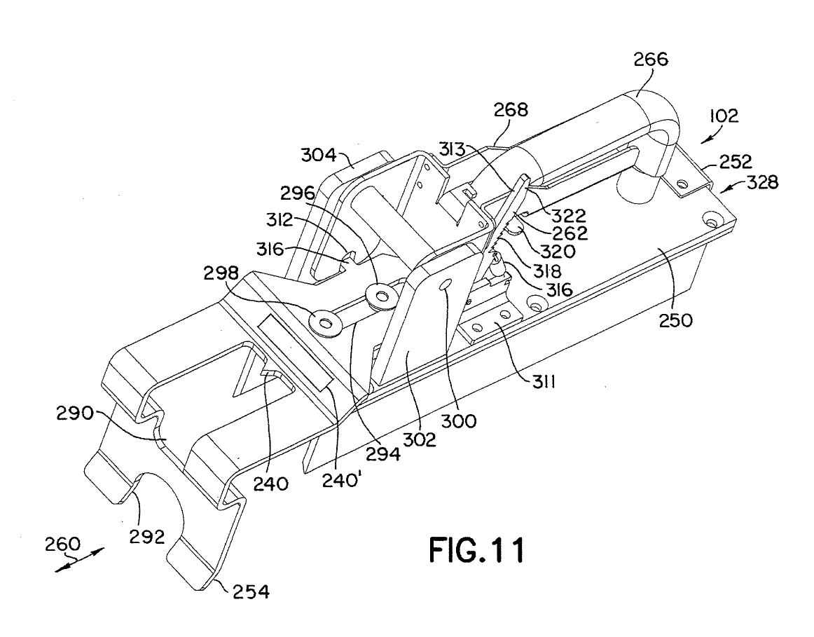

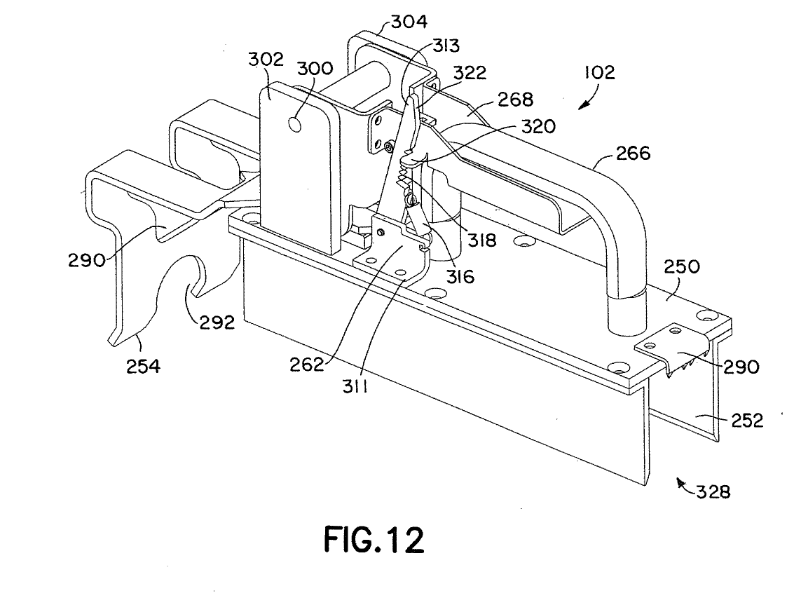

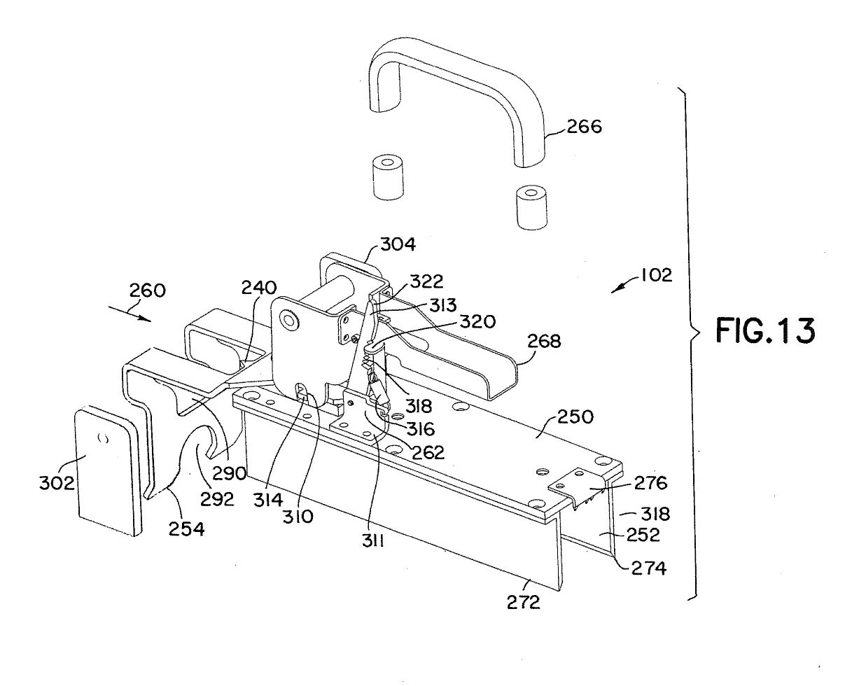

Referring now to FIG. 11 there is shown an isometric view of alignment fixture 102. Referring also to FIG. 12, there is shown an isometric view of alignment fixture 102. Referring also to FIG. 13, there is shown an exploded isometric view of alignment fixture 102. Alignment fixture 102 has frame 250 and grip portion 252 coupled to frame 250 and draw portion 254 coupled to frame 250. Latch 262 is coupled to frame 250 with latch 262 adapted to hold grip lever 268 in position after gripped toward handle 266. Grip portion 252 is shown having side plates 272, 274 sized to guide a piece of lumber and claw portion 276 adapted to dig in and grasp a piece of lumber. In alternate embodiments, any suitable gripping feature may be provided. Draw portion 254 has indicator 240 used to center on a mating mark or feature on the drawn board. Guide features 290, 292 are provided for a nailer that may be manual, pneumatic, automatic or otherwise where the nose of the nailer fits in guide features 290, 292 ensuring accurate nail placement. Draw portion 254 has slot 294 and is moveable in direction 260 relative to shouldered pins 296, 298 that are fixedly coupled to frame 250. Shaft or fasteners 300 are fixedly coupled to frame 250 with plates 302, 304. Handle 266 is further fixedly coupled to frame 250. Grip portion 268 pivots about shafts or fasteners 200, 302 and has slots 310, 312 that engage protrusions 314, 316 on draw portion 254 where drawing grip portion 268 toward handle 266 causes draw portion 254 to be drawn toward frame 250. A spring may be provided between grip portion 268 and handle 266 to lightly bias draw portion 254 away from frame 250 when released. Latch 262 has mount 310 fastened to frame 250 and release 312 pivotally coupled to mount 310. Release 312 has spring 316 that biases release 312 toward the rear portion 328 of frame 250. Release 312 has rachet portion 318 that engages tab portion 320 of grip 268 holding grip 268 in position until thumb portion 322 of release 312 is pushed away from rear portion 329 allowing rachet portion 318 to disengage tab 320. In practice, grip 268 is clenched toward handle 266 until the adjoining pieces of lumber mate and draw portion 254 flexes slightly providing a pre load at the joint where rachet 318 engages tab 320 allowing the user to let go of handle 266 and grip 268 and move out of the way while the joint is nailed and maintaining the pre load. After nailing, thumb portion 322 is engaged, releasing grip 268 and allowing draw portion 254 to relax allowing the fixture to be used at the next joint. In the embodiment shown, thumb portion 322 is drawn toward the rear of handle 268 to engage the rachet and pushed away from the end of handle 268 to release the rachet. In alternate embodiments, any suitable engagement and release may be provided, for example where thumb portion 322 is drawn toward the rear of handle 268 to disengage the rachet and pushed toward the end of handle 268 to release the rachet or otherwise.

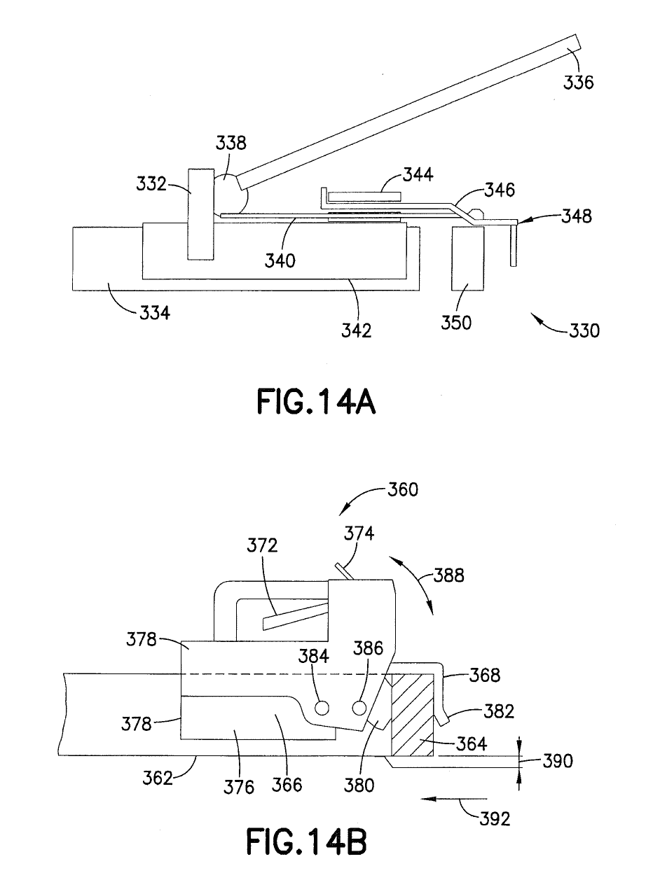

Referring now to FIG. 14A, there is shown a side view of an alternate embodiment alignment fixture 330. Fixture 330 has spring loaded clamp 332 adapted to clamp both sides of board 334 with coupler 340 and U-channel 342. Push handle 336 is coupled to crank 338 which is coupled to clamp finger 348 with coupler 340. Slide 344 constrains coupler 340 such that upon clamping ramp 346 pushes board 350 down and in alignment with board 334 for fastening. Push handle 336 may pushed and/or rotated such that crank 338 displaces coupler 340 where board 350 engages board 334 for fastening.

Referring now to FIG. 14B, there is shown a side view of an alternate embodiment alignment fixture 360. In the embodiment shown, fixture 360 aligns boards 362, 364 as previously described with additional features as will be described. Fixture 360 has clamp portions 366 and 368, frame portion 370 and engagement handle 372 with lock 374 adapted to lock engagement handle 372 in position during any portion of actuation. Clamp portion 366 has clamps 376, 378 on opposing sides of board 362 where clamps 376, 378 engage and lock the position of clamp 366 in relation to board 362 upon initial actuation of handle 372. In previous disclosed embodiments as well as the present embodiment, clamp or alignment portions including portion 366 with clamps 376, 378 may be fixed in width, for example to handle two by construction or otherwise or alternately may be adjustable in width to handle different width framing or sistered framing components as required. Similarly, clamp portion 368 has clamps 380, 382 on opposing sides of board 364 where clamps 380, 382 engage and lock the position of clamp 368 in relation to board 364 upon initial actuation of handle 372. Pivot point 386 is provided between frame 370 and clamp 366. Pivot point 386 is provided between frame 370 and clamp 368. After initial actuation of handle 372, the user may pivot 388 handle 370 such that the elevation 390 of board 362 with respect to board 364 (or vise versa) may be adjusted to align upper or lower edges of the boards as desired. Upon reaching a desired alignment between boards 362, 364, the user may complete further and final actuation of handle 372 causing board 364 to be drawn 392 toward board 362 where clamp portion 366 and/or clamp portion 368 is moved in slots or otherwise in relation to frame 370 for locking boards 362, 364 in the desired position for fastening as previously described. In alternate embodiments, more or less clamping or relative board adjustments may be provided, for example, lateral adjustment in addition to or instead of elevation adjustment.

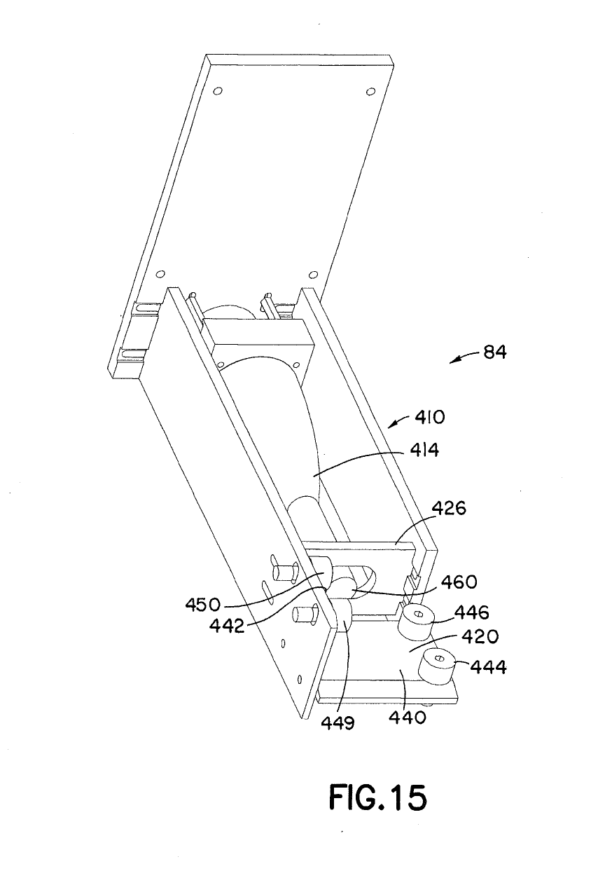

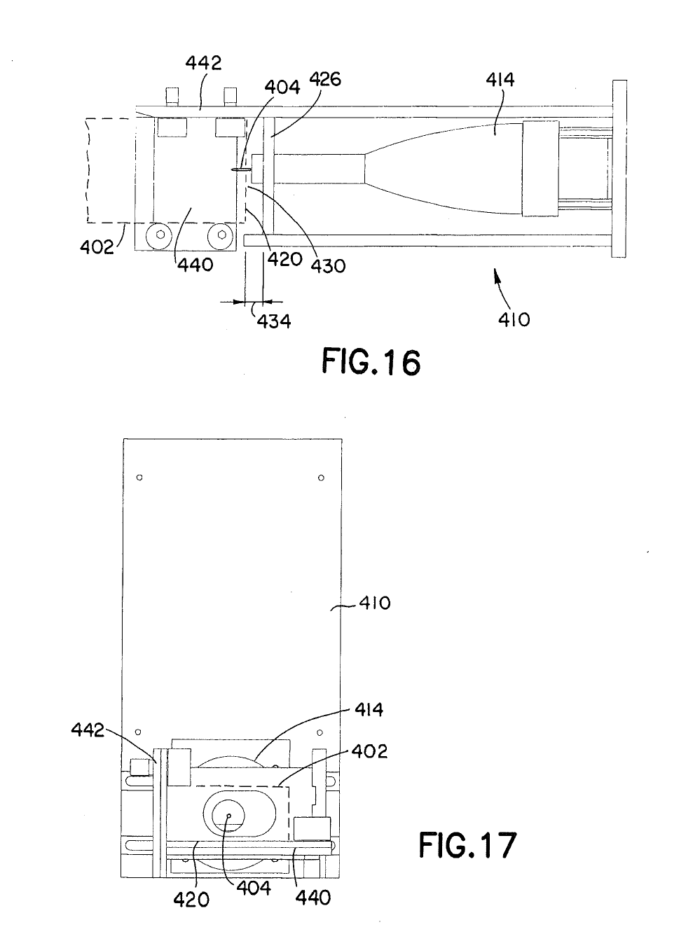

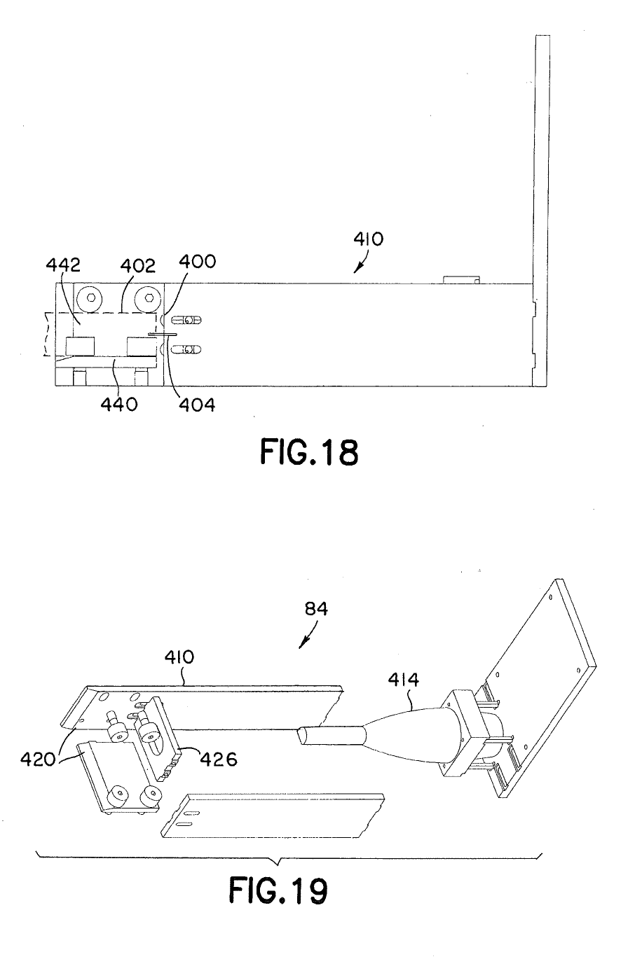

Referring now to FIG. 15, there is shown a isometric view of pin setter 84. Referring also to FIG. 16, there is shown a top view of pin setter 84. Referring also to FIG. 17, there is shown an end view of pin setter 84. Referring also to FIG. 18, there is shown a side view of pin setter 84. Referring also to FIG. 19, there is shown an exploded isometric view of pin setter 84. Pin setter 84 fires pins accurately into end 400 of stud 400 or wood component 402 to enable fast on-site, or within factory alignment and assembly of wall panels or assemblies where pins are located to mate with mating features, for example, bores or holes made by stick machine 80 (FIG. 1). Interior (or exterior) wall components may be cut, ends labeled and ends quickly pinned with pin setter 84. Pin-setter 84 may either be affixed to Stick Machine 80, or be used as a stand-alone device. For example, plates may be drilled at pinning locations on Stick Machine 80. Compact sets of boards (vs panelized wall with large volume of air to transport) may be efficiently transported to site, carried to the place of installation, laid out, marks (e.g. letters or numbers) matched, boards tapped together using pins, and the wall nailed after assembly and tilted into place. This method may be particularly suitable for interior walls or home improvement projects where transport or handling of a finished wall is difficult. Pin setter 84 may also be used to set pins in the ends of rafters or joists to improve the speed and accuracy of installation, for example, to ridge beams or rim joists as previously shown. Pin setter 84 may be a pin setting apparatus 84 adapted to place pin 404 in wood component 402. Pin setter 84 is shown having frame 410, pin insertion portion 414 coupled to frame 410, pin insertion portion 414 adapted to insert pin 404 into wood component 402. Guide portion 420 is coupled to frame 410, guide portion 420 adapted to guide the wood component 402 toward the pin insertion portion 414. Stop portion 426 is coupled to frame 410 with stop portion 426 adapted to stop surface 430 of wood component 402. Pin 404 is inserted into the surface 430 of wood 402 such that pin 404 extends from surface 430 of wood 402 at a fixed length 434. In the embodiment shown, guide portion 420 has first and second guide surfaces 440, 442 where guide surfaces 440, 442 have tapered inlets to provide for easy insertion. Rollers 444, 446, 448, 450 cooperate with surfaces 440, 442 to ensure pin 404 is inserted consistently with respect to the sides of board 402. Insertion portion 414 may be a pneumatic nailer where the nose 460 of nailer 414 protrudes beyond stop surface 426 preventing misfires. In practice, board 402 depresses nose 460 until the end 430 engages stop 426 allowing nailer 414 to insert pin 404 in a consistent manner.

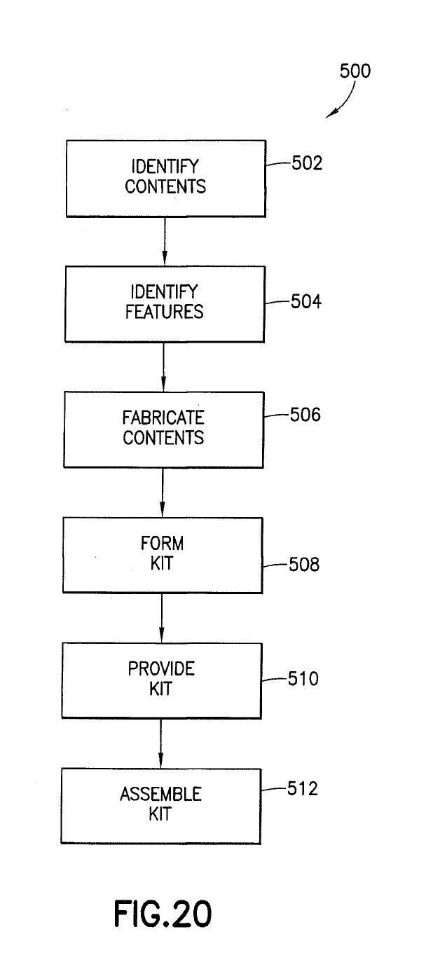

Referring now to FIG. 20, there is shown an exemplary process flow diagram 500 of an exemplary method of framing a structure at a job site. The method of framing has step 502 of identifying the contents of a framing material kit corresponding to at least a portion of a structure. The structure may be pre determined or may be determined or modified during the construction process. The method of framing has step 504 of identifying features of the contents of the framing material kit. Features may include cut lengths, sizes and shapes. Features may include mating pins and sockets or slots or identification indicia, preset fasteners or otherwise. The framing material kit may comprises lumber or otherwise. The method of framing has step 506 of fabricating the contents of the framing material kit, the contents having the framing components. The framing components may be pre cut to length and size to form at least a portion of the structure. The step of fabricating may include providing the framing components with mating features such as pins and mating sockets or slots that mate during assembly of the structure. The step of fabricating may include providing at least a portion of the framing components with identification indicia, the identification indicia indicating where the mating framing components are to mate. All of or at least a portion of the framing components may have identification indicia, the identification indicia indicating which of the mating framing components mate with other framing components. At least a portion of the framing components in the kit may have at least one fastener pre set in the framing component, the fastener provided to fasten at least a portion of the mating framing components together. The method of framing has step 508 of forming the framing material kit. The step of forming may include palletizing or otherwise grouping the material. Alternately, the step of forming may involve providing the material as it is fabricated to the workers or otherwise at a job site where the material may be made at the job site or otherwise. At least a portion of the framing material kit may be provided with the framing components in an order that the framing components are to be assembled. The step of forming may include a step assembling the framing material kit at a site different than the job site and transporting the framing material kit to the job site. The method of framing has step 510 of providing a framing material kit to the job site. The kit may be provided in real time to the job site or shipped from a remote site. Providing the framing material kit may be completed at the job site. The method of framing has step 512 of assembling mating framing components from the framing components to form at least a portion of the structure by mating the mating pins and the mating sockets and fastening the mating framing components together. In alternate embodiments, more or less steps may be provided utilizing and/or with features of the disclosed embodiments or otherwise.

In accordance with an exemplary method, a method of framing a structure at a job site is provided. The method of framing has a step of providing a framing material kit having framing components, the framing components being precut to length and size to form at least a portion of the structure, the framing components having mating pins and mating sockets that mate during assembly of the structure. A step of assembling mating framing components from the framing components to form the portion of the structure by mating the mating pins and the mating sockets and fastening the mating framing components together is provided.

In accordance with an exemplary embodiment, an alignment fixture adapted to align a first lumber component with a second lumber component is provided. The alignment fixture has a frame and a grip portion coupled to the frame, the grip portion adapted to grip the first lumber component. A draw portion is provided coupled to the frame, the draw portion adapted to draw the second lumber component toward the first lumber component in a fastening position. A latch is provided coupled to the frame, the latch adapted to hold the first lumber component and the second lumber component in the fastening position. The grip may alternately be actuated automatically with a pneumatic or electric actuator.

In accordance with another exemplary embodiment, a pin setting apparatus adapted to place a pin in a wood component is provided. The pin setting apparatus has a frame and a pin insertion portion coupled to the frame, the pin insertion portion adapted to insert the pin into the wood component. A guide portion is provided coupled to the frame, the guide portion adapted to guide the wood component toward the pin insertion portion. A stop portion is provided coupled to the frame, the stop portion adapted to stop a surface of the wood component. The pin is inserted into the surface of the wood such that the pin extends from the surface of the wood at a fixed length.

It should be understood that the foregoing description is only illustrative of the invention. Various alternatives and modifications can be devised by those skilled in the art without departing from the invention. Accordingly, the present invention is intended to embrace all such alternatives, modifications and variances.

What is claimed is:

1. A method of framing a structure at a job site, the method of framing comprising:
providing a framing material kit having framing components, the framing components being pre cut to length and size to form at least a portion of the structure, the framing components having mating pins and mating sockets that mate during assembly of the structure; and
assembling mating framing components from the framing components to form the portion of the structure by mating the mating pins and the mating sockets and fastening the mating framing components together.

2. The method of framing of claim 1 wherein at least a portion of the framing components have identification indicia, the identification indicia indicating where the mating framing components are to mate.

3. The method of framing of claim 1 wherein at least a portion of the framing material kit is provided with the framing components in an order that the framing components are to be assembled.

4. The method of framing of claim 1 wherein at least a portion of the framing components have identification indicia, the identification indicia indicating which of the mating framing components mate.

5. The method of framing of claim 1 wherein at least a portion of the framing components in the kit have at least one fastener pre set in the framing component, the fastener provided to fasten at least a portion of the mating framing components together.

6. The method of framing of claim 1 wherein assembling the framing material kit at a site different than the job site and transporting the framing material kit to the job site is provided.

7. The method of framing of claim 1 wherein providing the framing material kit is completed at the job site.

8. The method of framing of claim 1 wherein the framing material kit comprises lumber.

9. An alignment fixture adapted to align a first lumber component with a second lumber component, the alignment fixture comprising:
a frame;
a grip portion coupled to the frame, the grip portion adapted to grip the first lumber component;
a draw portion coupled to the frame, the draw portion adapted to draw the second lumber component toward the first lumber component in a fastening position; and
a latch coupled to the frame, the latch adapted to hold the first lumber component and the second lumber component in the fastening position.

10. The alignment fixture of claim 9 wherein the grip portion has first and second side plates adapted to guide the first lumber component in the fastening position.

11. The alignment fixture of claim 9 further comprising a view port allowing a user to view that the first lumber component and the second lumber component are in the fastening position prior to fastening.

12. The alignment fixture of claim 9 further comprising a detection device having a location indication that indicates the first lumber component and the second lumber component are in the fastening position prior to fastening.

13. The alignment fixture of claim 9 wherein the latch comprises a releasable latch.

14. The alignment fixture of claim 9 wherein the draw portion draws the second lumber component toward the first lumber component with a manual tightening.

15. A pin setting apparatus adapted to place a pin in a wood component, the pin setting apparatus comprising:
a frame;
a pin insertion portion coupled to the frame, the pin insertion portion adapted to insert the pin into the wood component;
a guide portion coupled to the frame, the guide portion adapted to guide the wood component toward the pin insertion portion; and
a stop portion coupled to the frame, the stop portion adapted to stop a surface of the wood component;
wherein, the pin is inserted into the surface of the wood such that the pin extends from the surface of the wood at a fixed length.

16. The pin setting apparatus of claim 15 wherein the pin is inserted into the end of a wood framing component at a predetermined location.

17. The pin setting apparatus of claim 15 wherein the pin is inserted into the end of a wood framing component with the pin extending a predetermined length from the end of the wood framing component.

18. The pin setting apparatus of claim 15 wherein the pin insertion portion comprises a pneumatic nailer.

19. The pin setting apparatus of claim 15 wherein the guide portion comprises guide surfaces and rollers.

20. The pin setting apparatus of claim 15 wherein the guide portion comprises tapered guide surfaces.
